(19) United States
(12) Patent Application Publication
(10) Pub. No.: US 2014/0307172 A1
(43) Pub. Date: Oct. 16, 2014

(54) Channel State Information Assisted Decision Feedback Equalizer for Mobile ATSC HDTV Receiver

(71) Applicant: Lin Yang, (US)

(72) Inventor: Lin Yang, Milpitas, CA (US)

(21) Appl. No.: 13/890,097

(22) Filed: May 8, 2013

Related U.S. Application Data
(60) Provisional application No. 61/812,156, filed on Apr. 15, 2013.

(51) Int. Cl. H04N 5/44

(52) U.S. Cl. CPC H04N 5/4401
USPC 348/731; 348/725

(57) ABSTRACT

This invention is a fast decision feedback equalizer based on promptly updated channel characteristics to enable ATSC HDTV signal reception in a mobile environment (e.g. in a moving car, walking, on a bus, etc.) by removing the Doppler interference.

This application claims the benefit of the U.S. Provisional application No. 61/812,156, filed Apr. 15, 2013.

### TECHNICAL FIELD

The present invention relates generally to an application in a digital television system, more specifically the present invention relates to a single or multiple antenna ATSC terrestrial DTV receivers for indoor and mobile users.

### BACKGROUND

Traditionally, terrestrial ATSC HDTV programming can only be viewed on a TV console in a fixed or static environment (e.g. family room).

Today, mobile devices with screens are ubiquitous. Examples include, but are not limited to; laptops, tablets, cell phones, car infotainment systems, etc. However, terrestrial ATSC HDTV programming cannot be viewed on these devices in a mobile environment. This is because existing ATSC HDTV receivers cannot have stable reception in a mobile environment due to the Doppler interference caused by mobile conditions.

This invention is a fast decision feedback equalizer based on promptly updated channel characteristics to enable ATSC HDTV signal reception in a mobile environment (e.g. in a moving car, walking, on a bus, etc.) by removing the Doppler interference.

The following patents are herein incorporated by reference: U.S. patent application Ser. No. 12/512,901 entitled A NOVEL EQUALIZER FOR SINGLE CARRIER TERRESTRIAL DTV RECEIVER, by Yang; U.S. patent application Ser. No. 12/554,925 entitled A MULTIPLE TUNER ATSC TERRESTRIAL RECEIVER FOR INDOOR & MOBILE USERS, by Yang; U.S. patent application Ser. No. 12/572,236 entitled A MULTIPLE TUNER TERRESTRIAL DTV RECEIVER FOR INDOOR & MOBILE USERS, by Yang; U.S. patent application Ser. No. 13/871,869 entitled WI-FI ATSC TV ANTENNA, by Yang; U.S. patent application Ser. No. 13/872,917 entitled MULTIPLE ANTENNA ATSC HDTV RECEIVER DEVICE, by Yang; and U.S patent application Ser. No. 13/889,158 entitled A METHOD OF CHANNEL CHARACTERIZATION FOR MOBILE ATSC HDTV RECEIVER, by Yang.

Given the above-referenced applications, the present invention provides a new method to optimize the following functions: the function of Channel State Information from one or more antennas, the function of MRC (Maximum Ratio Combining) Frequency Domain Equalizer, the function of Noise Whitening Filter Coefficient Generator, the function of Noise Whitening Filter Coefficient, and the function of Noise Whitening Filter.

### SUMMARY OF INVENTION

This invention is a method of Channel State Information Assisted Decision Feedback Equalizer for Mobile ATSC HDTV Receiver in order to remove the Doppler interference present in a mobile situation.

### BRIEF DESCRIPTION OF DRAWINGS

Having thus described the invention in general terms, reference will now be made to the accompanying drawings, which are not necessarily drawn to scale, and wherein:

FIG. 1 shows an example of a Terrestrial ATSC HDTV Receiver.

FIG. 2 shows the Channel State Information Assisted Equalizer.

### DETAILED DESCRIPTION

The present inventions now will be described more fully hereinafter with reference to the accompanying drawings, in which some examples of the embodiments of the inventions are shown. Indeed, these inventions may be embodied in many different forms and should not be construed as limited to the embodiments set forth herein; rather, these embodiments are provided by way of example so that this disclosure will satisfy applicable legal requirements. Like numbers refer to like elements throughout.

### COMPONENT LIST

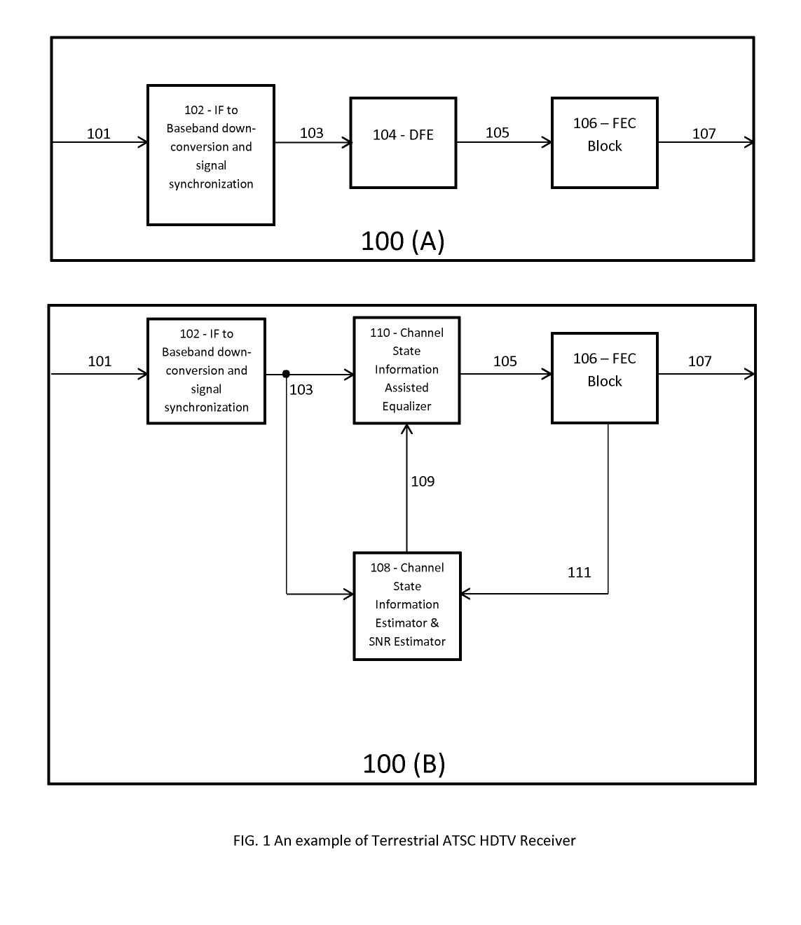

FIG. 1
100—Terrestrial ATSC HDTV Receiver (an example)
101—Digital ATSC IF Signal
102—IF to Baseband down-conversion and signal synchronization. Includes but not limited to frequency shifting, low-pass filter, symbol timing recovery, carrier recovery, SRRC filter, Field Synchronization, segment synchronization
103—Synchronized baseband ATSC HDTV signal from one or more antennas
104—Decision Feedback Equalizer
105—Demodulated ATSC HDTV Signal
106—Forward Error Correction (FEC) Block: includes Viterbi Decoder, De-interleaver, R.S. Decoder, and De-randomizer
107—MPEG TS (Transport Stream)
108—Channel State Information Estimator & SNR (Signal-To-Noise Ratio) Estimator
109—Channel State Information from one or more antennas
110—Channel State Information Assisted Equalizer
111—Decoded ATSC HDTV Signal

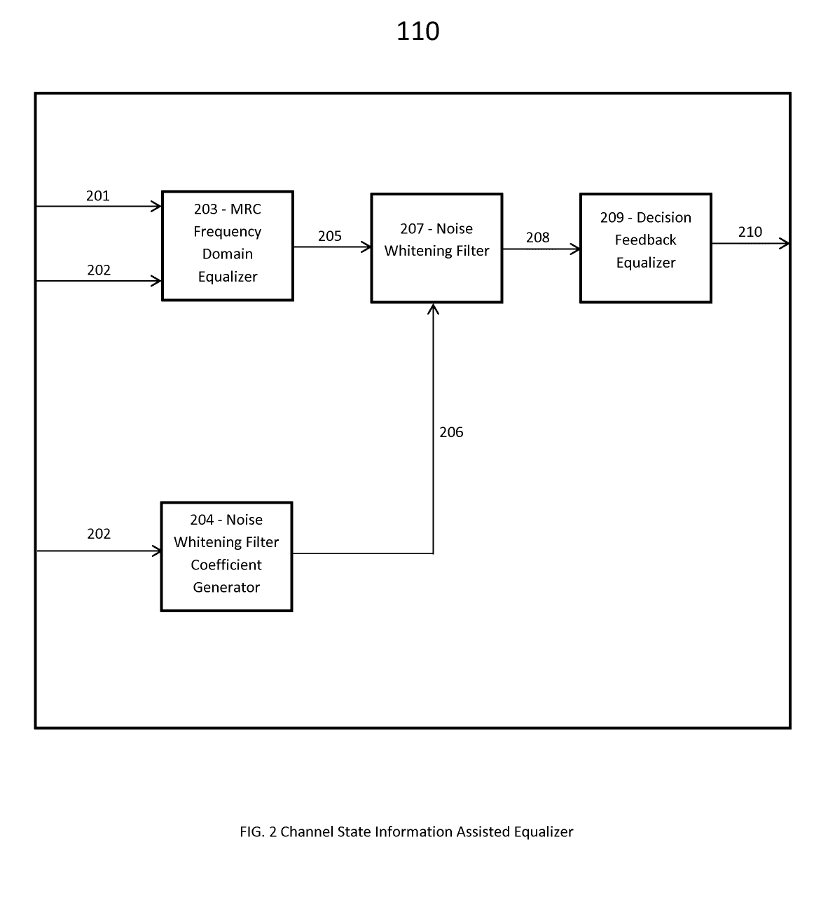

FIG. 2-110
201 (also 103 in FIG. 1)—Synchronized baseband ATSC HDTV signal from one or more antennas
202 (also 109 in FIG. 1)—Channel State Information from one or more antennas
203—MRC (Maximum Ratio Combining) Frequency Domain Equalizer
204—Noise Whitening Filter Coefficient Generator
205—MRC Equalized Signal with Colored Noise
206—Noise Whitening Filter Coefficient
207—Noise Whitening Filter
208—Pre-filtered MRC Equalized Signal with White Noise
209—Decision Feedback Equalizer
210 (also 105 in FIG. 1)—Demodulated ATSC HDTV Signal

FIG. 1(100A) is an example of a traditional ATSC HDTV receiver functional block diagram.

The digital ATSC IF Signal (101) goes in to the functional block (102) which performs the following functions: IF to Baseband down-conversion and signal synchronization. Includes but not limited to frequency shifting, low-pass filter, symbol timing recovery, carrier recovery, SRRC filter, Field Synchronization, and segment synchronization.

The output of functional block (102) is a synchronized baseband ATSC HDTV signal (103), which goes in to a decision feedback equalizer (104). The demodulated ATSC HDTV Signal (105) from the decision feedback equalizer (104) goes in to the Forward Error Correction Block (106), which performs the following functions: Viterbi Decoder, De-interleaver, R.S. Decoder, and De-randomizer, and then generates the MPEG TS (107).

FIG. 1(100B) is an example of a new ATSC HDTV receiver functional block diagram applying this invention.

The invention replaces the traditional decision feedback equalizer (104) in FIG. 1(A) with the Channel State Information Estimator & SNR Estimator (108) and Channel State Information Assisted Equalizer (110).

The channel state information from one or more antennas (109) is generated from the Channel State Information Estimator & SNR Estimator (108) based on the synchronized baseband ATSC HDTV signal from one or more antennas (103) and the decoded ATSC HDTV signal (111).

FIG. 2:

201 are the synchronized baseband ATSC HDTV signals from one or more antennas. 202 is the channel state information, which includes channel impulse response and Signal-To-Noise Ratio (SNR), for one or more antennas. Both (201) and (202) goes to the MRC (Maximum Ratio Combining) Frequency Domain Equalizer (203) for combining and equalization. The equalized results (205) have colored noise because of the noise enhancement effects during the equalization process. In order to remove the colored noise from the equalized signal, a noise whitening filter is needed. 204 generates the Noise Whitening Filter Coefficient based on the input (202). The Noise Whitening Filter (207) uses the Noise Whitening Filter Coefficient (206) to remove the colored noise of the MRC Equalized Signal with Colored Noise (205) and outputs the Pre-filtered MRC Equalized Signal with White Noise (208). The Decision Feedback Equalizer (209) uses the Noise Whitening Filter Coefficient (206) as its filter coefficient to generate a Demodulated ATSC HDTV Signal (210) from the Pre-filtered MRC Equalized Signal with White Noise (208).

What is claimed is:

1. A method of terrestrial ATSC HDTV signal reception comprising of:
a. The function of Channel State Information from one or more antennas,
b. The function of MRC (Maximum Ratio Combining) Frequency Domain Equalizer,
c. The function of MMSE (Minimum Means Square Error) Optimized Noise Whitening Filter Coefficient Generator,
d. The function of MMSE Optimized Noise Whitening Filter Coefficient,
e. The function of MMSE Optimized Noise Whitening Filter, and
f. The function of Decision Feedback Equalizer.

2. The method of claim 1 is associated with a single antenna being coupled to a single tuner.

3. The method of claim 1 is associated with a single antenna being coupled to a plurality of tuners.

4. The method of claim 1 is associated with a plurality of antennas being coupled to a plurality of tuners.

5. The method of claim 1 is associated with a single Wi-Fi ATSC TV antenna.

6. The method of claim 1 is associated with a plurality of Wi-Fi ATSC TV antennas.
